(19) United States
(12) Patent Application Publication
(10) Pub. No.: US 2024/0183216 A1
(43) Pub. Date: Jun. 6, 2024

(54) SELF-CINCHING DEVICE FOR FENESTRATION UNITS

(71) Applicant: Andersen Corporation, Bayport, MN (US)

(72) Inventors: Paul Michael Allan Morris, Roseville, MN (US); Justin Michael Depew, Stillwater, MN (US)

(21) Appl. No.: 18/526,696

(22) Filed: Dec. 1, 2023

Related U.S. Application Data
(60) Provisional application No. 63/429,713, filed on Dec. 2, 2022.

(51) Int. Cl. E06B 3/54

(52) U.S. Cl. CPC E06B 3/5481

(57) ABSTRACT

Embodiments herein relate to self-cinching devices for fenestration units. In a first aspect, a self-cinching clip device can be included having a base plate. The base plate can include a screw boss. The screw boss can define an oblong fastener aperture and a sloped surface. The sloped surface can be adjacent the oblong fastener aperture. The self-cinching clip device can include a foot member. The foot member can be disposed on a first end of the base plate. The self-cinching clip device can further include a retention lip. The retention lip can be disposed on a second end of the base plate. The sloped surface can have a first side and a second side opposite the first side along an axis interconnecting the foot member and the retention lip. The first side of the sloped surface can have a larger diameter than the second side.

This application claims the benefit of U.S. Provisional Application No. 63/429,713, filed Dec. 2, 2022, the content of which is herein incorporated by reference in its entirety.

### FIELD

Embodiments herein relate to self-cinching devices. More specifically, embodiments herein relate to self-cinching devices for fenestration units.

### BACKGROUND

Fenestration units can include windows, patio doors, entry doors, and the like. Such fenestration units typically include frame members such as side and head jambs, sills, sashes, glazing units, panels, and the like. Such fenestration units typically also include one or more trim pieces. Trim pieces add to the aesthetics of a fenestration unit and, in some cases, also conceal hardware. Typically, the various components of a fenestration unit should be securely fastened together. This can be done using fasteners, adhesives, and various pieces of attachment hardware.

### SUMMARY

Embodiments herein relate to self-cinching devices for fenestration units. In a first aspect, a self-cinching clip device can be included having a base plate. The base plate can include a screw boss. The screw boss can define an oblong fastener aperture and a sloped surface. The sloped surface can be adjacent to the oblong fastener aperture. The self-cinching clip device can include a foot member. The foot member can be disposed on a first end of the base plate. The self-cinching clip device can further include a retention lip. The retention lip can be disposed on a second end of the base plate, the second end opposite the first end. The sloped surface can have a first side and a second side opposite the first side along an axis interconnecting the foot member and the retention lip. The first side of the sloped surface can have a larger diameter than the second side.

In a second aspect, in addition to one or more of the preceding or following aspects, or in the alternative to some aspects, the sloped surface can be sloped at a countersink angle of 65 to 120 degrees.

In a third aspect, in addition to one or more of the preceding or following aspects, or in the alternative to some aspects, the self-cinching clip device can be formed of an injection molded or 3D printed polymer.

In a fourth aspect, in addition to one or more of the preceding or following aspects, or in the alternative to some aspects, the self-cinching clip device can be at least partially formed of a metal.

In a fifth aspect, in addition to one or more of the preceding or following aspects, or in the alternative to some aspects, the foot member can include an end surface, wherein the end surface can be configured to make contact with and exert a force against a panel or a glazing unit in a direction substantially parallel to an axis interconnecting the foot member and the retention lip.

In a sixth aspect, in addition to one or more of the preceding or following aspects, or in the alternative to some aspects, the foot member can include one or more connection mechanisms.

In a seventh aspect, in addition to one or more of the preceding or following aspects, or in the alternative to some aspects, the one or more connection mechanisms can be arranged to extend backward from the foot member in a direction toward the retention lip.

In an eighth aspect, in addition to one or more of the preceding or following aspects, or in the alternative to some aspects, the one or more connection mechanisms can include one or more snap fit tabs.

In a ninth aspect, in addition to one or more of the preceding or following aspects, or in the alternative to some aspects, the shape of the sloped surface can be defined by portions of two interconnected countersunk holes.

In a tenth aspect, a method of securing a panel or glazing unit within a frame member can be included. The method can include placing the panel or glazing unit into contact with the frame member and placing a self-cinching clip device on a surface of the frame member adjacent the panel or glazing unit. The self-cinching clip device can include a base plate and the base plate can include a screw boss. The screw boss can define an oblong fastener aperture and can define a sloped surface. The sloped surface can be adjacent the oblong fastener aperture. The method can further include driving a fastener with a head through the oblong fastener aperture and into the frame member sufficiently far to make contact between the fastener head and the sloped surface. The method can include further driving the fastener causing the self-cinching clip device to move in direction perpendicular to a lengthwise axis of the fastener along the surface of the frame member as the head of the fastener moves along the sloped surface and exert a force on the panel or glazing unit.

In an eleventh aspect, in addition to one or more of the preceding or following aspects, or in the alternative to some aspects, the self-cinching clip device exerts a force on the panel or glazing unit of about 3 to 5 lbs per lineal inch.

In a twelfth aspect, in addition to one or more of the preceding or following aspects, or in the alternative to some aspects, the fastener can be driven to a final point at a torque of 13 to 16 inch pounds.

In a thirteenth aspect, in addition to one or more of the preceding or following aspects, or in the alternative to some aspects, wherein the fastener is a screw.

In a fourteenth aspect, in addition to one or more of the preceding or following aspects, or in the alternative to some aspects, the frame member can include a jamb member.

In a fifteenth aspect, in addition to one or more of the preceding or following aspects, or in the alternative to some aspects, the shape of the sloped surface can be defined by portions of two interconnected countersunk holes.

In a sixteenth aspect, in addition to one or more of the preceding or following aspects, or in the alternative to some aspects, the sloped surface can be sloped at a countersink angle of 65 to 120 degrees.

In a seventeenth aspect, a fenestration unit can be included having a structural member, a panel or glazing unit, and a self-cinching clip device. The self-cinching clip device can include a base plate and the base plate can include a screw boss. The screw boss can define an oblong fastener aperture and a sloped surface. The sloped surface can be adjacent to the oblong fastener aperture. The clip device can further include a foot member. The foot member can be disposed on a first end of the base plate. The self-cinching clip device can be connected to the structural member and exert a force against the panel or glazing unit. The sloped surface can have a first side and a second side opposite the first side along an axis interconnecting the first end of the base plate and an opposite end of the base plate. The first side can have a larger diameter than the second side.

In an eighteenth aspect, in addition to one or more of the preceding or following aspects, or in the alternative to some aspects, the self-cinching clip device further can include a retention lip, wherein the retention lip can be disposed on a second end of the base plate, the second end opposite the first end.

In a nineteenth aspect, in addition to one or more of the preceding or following aspects, or in the alternative to some aspects, the sloped surface can be sloped at a countersink angle of 65 to 120 degrees.

In a twentieth aspect, in addition to one or more of the preceding or following aspects, or in the alternative to some aspects, the foot member can include an end surface. The end surface can be configured to make contact with and exert a force against a panel or a glazing unit in a direction substantially parallel to an axis interconnecting the foot member and the retention lip.

In a twenty-first aspect, in addition to one or more of the preceding or following aspects, or in the alternative to some aspects, the foot member can include one or more connection mechanisms.

In a twenty-second aspect, in addition to one or more of the preceding or following aspects, or in the alternative to some aspects, the one or more connection mechanisms can be arranged to extend backward from the foot member in a direction toward a retention lip.

In a twenty-third aspect, in addition to one or more of the preceding or following aspects, or in the alternative to some aspects, the self-cinching clip device can be formed of an injection molded or 3D printed polymer.

In a twenty-fourth aspect, in addition to one or more of the preceding or following aspects, or in the alternative to some aspects, the structural member can include a jamb member.

In a twenty-fifth aspect, in addition to one or more of the preceding or following aspects, or in the alternative to some aspects, the shape of the sloped surface can be defined by portions of two interconnected countersunk holes.

In a twenty-sixth aspect, a fenestration unit can be included having a first component, a second component, and a self-cinching device. The self-cinching device can include a base plate and the base plate can include a screw boss. The screw boss can define an oblong fastener aperture and can define a sloped surface. The sloped surface can be adjacent the oblong fastener aperture. The self-cinching device can include a foot member. The foot member can be disposed on a first end of the base plate. The self-cinching device can be connected to the first component and can exert a force against the second component. The sloped surface can have a first side and a second side opposite the first side along an axis interconnecting the first end of the base plate and an opposite end of the base plate. The first side can have a larger diameter than the second side.

In a twenty-seventh aspect, in addition to one or more of the preceding or following aspects, or in the alternative to some aspects, the self-cinching device further can include a retention lip, wherein the retention lip can be disposed on a second end of the base plate, the second end opposite the first end.

In a twenty-eighth aspect, in addition to one or more of the preceding or following aspects, or in the alternative to some aspects, the sloped surface can be sloped at a countersink angle of 65 to 120 degrees.

In a twenty-ninth aspect, in addition to one or more of the preceding or following aspects, or in the alternative to some aspects, the foot member can include an end surface, wherein the end surface can be configured to make contact with and exert a force against the second component in a direction substantially perpendicular to a plane defined by the end surface.

In a thirtieth aspect, in addition to one or more of the preceding or following aspects, or in the alternative to some aspects, the foot member can include one or more connection mechanisms.

In a thirty-first aspect, in addition to one or more of the preceding or following aspects, or in the alternative to some aspects, the self-cinching device can be formed of an injection molded or 3D printed polymer.

In a thirty-second aspect, in addition to one or more of the preceding or following aspects, or in the alternative to some aspects, the first component can include a jamb member.

In a thirty-third aspect, in addition to one or more of the preceding or following aspects, or in the alternative to some aspects, the first component can include an astragal.

In a thirty-fourth aspect, in addition to one or more of the preceding or following aspects, or in the alternative to some aspects, the fenestration unit can be a self-cinching cap device.

In a thirty-fifth aspect, in addition to one or more of the preceding or following aspects, or in the alternative to some aspects, the shape of the sloped surface can be defined by portions of two interconnected countersunk holes.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a simplified front elevation view of an entry door system in accordance with various embodiments herein.

FIG. 2 is a perspective view of a self-cinching clip device in accordance with various embodiments herein.

FIG. 3 is a perspective view of a self-cinching clip device in accordance with various embodiments herein.

FIG. 4 is a perspective view of a self-cinching clip device in accordance with various embodiments herein.

FIG. 5 is a schematic top view of portions of a screw boss in accordance with various embodiments herein.

FIG. 6 is a perspective view of a self-cinching clip device in accordance with various embodiments herein.

FIG. 7 is a cross-sectional view of a self-cinching clip device as taken along line 7-7′ of FIG. 4.

FIG. 8 is a cross-sectional view of a self-cinching clip device showing a fastener being inserted in accordance with various embodiments herein.

FIG. 9 is a schematic sectional view of components of a fenestration unit as taken along line 9-9′ of FIG. 1 in accordance with various embodiments herein.

FIG. 10 is a perspective view of a self-cinching device in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As described above, the components of a fenestration unit generally should be securely fastened together. This can be done using fasteners, adhesives, and various pieces of attachment hardware. However, some fasteners or hardware may be relatively difficult to attach depending on the structure of the components around the attachment point. Further, some fasteners may be relatively hard to position properly. Further some fasteners or hardware don't accommodate for dimensional variation of system components to ensure a tight fit.

Embodiments herein can include self-cinching clip devices and fenestration units including the same. The self-cinching clip devices herein can be easy to attach and position properly. In addition, self-cinching clip devices herein accommodate for dimensional variation of system components to ensure a tight fit. As an example, a self-cinching clip device herein can include a base plate, a foot member, and a retention lip. The base plate can include a screw boss. The screw boss can define an oblong fastener aperture and a sloped surface adjacent the oblong fastener aperture. The self-cinching clip device can also include a foot member disposed on a first end of the base plate and a retention lip disposed on a second end of the base plate, the second end opposite the first end. The sloped surface can be sloped along an axis interconnecting the foot member and the retention lip.

In use, a panel or glazing unit can be placed into contact with a frame member and then a self-cinching clip device herein can be placed on a surface of the frame member adjacent the panel or glazing unit. A fastener such as a screw can then be driven through the oblong fastener aperture and into the frame member sufficiently far to make contact between the fastener head (such as the head of a screw) and a surface of the screw boss. The fastener can then be further driven in causing the fastener head to exert a force downward on the surface. Contact of the head of the fastener with the surface can then translate downward force into force in a lateral direction, but since the partially inserted fastener is laterally fixed in place the self-cinching clip device itself moves in a direction perpendicular to a lengthwise axis of the fastener along the surface of the frame member. This results in the self-cinching clip device exerting a force on the panel or glazing unit.

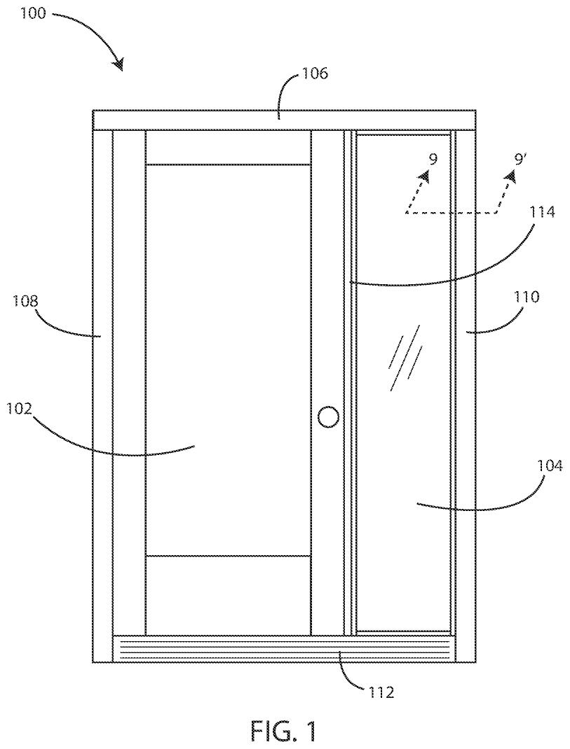

Self-cinching clip devices herein can be used with various fenestration systems including, but not limited to, entry door systems, patio door systems, windows, and the like. Referring now to FIG. 1, a simplified front elevation view is shown of an entry door system 100 in accordance with various embodiments herein. The entry door system 100 can include an entry door 102 and a direct set glass side light 104. The framing of the entry door system 100 can include a head jamb 106, a first side jamb 108, a second side jamb 110, and a sill assembly 112. A mulling post 114 can also be included between the entry door 102 and the side light 104. The self-cinching clip devices herein can be used to aid in securing panels and/or glazing units into frames and/or one or more frame components of fenestration systems. While an entry door system 100 is shown in FIG. 1, it will be appreciated that self-cinching devices herein can be used with all different types of fenestration systems also including window systems, patio doors, and the like. In various embodiments, the fenestration system may lack a sill assembly and all four sides may be jambs such as in the case of a transom unit.

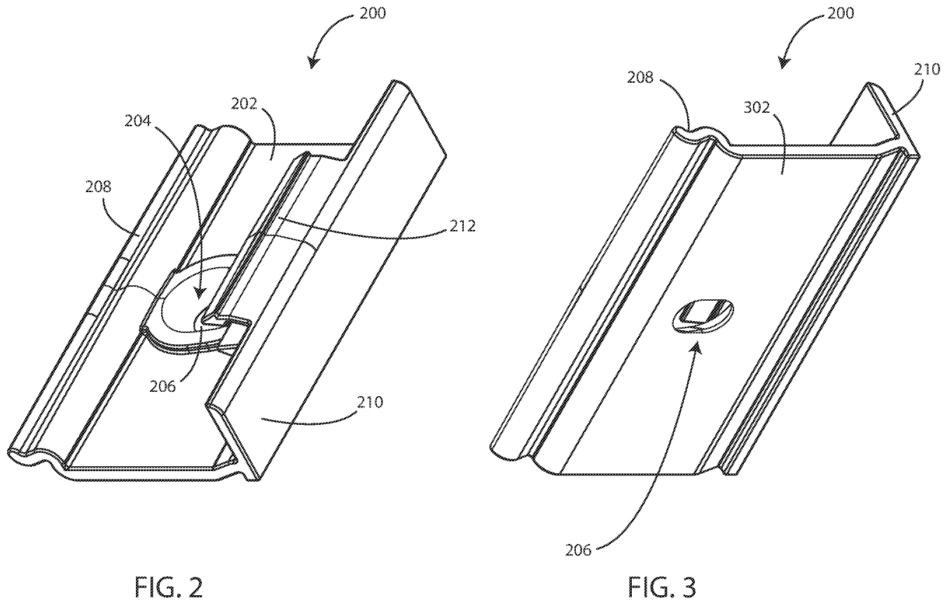

Referring now to FIG. 2, a perspective view of a self-cinching clip device 200 is shown in accordance with various embodiments herein. The self-cinching clip device 200 includes a base plate 202, a retention lip 208, and a foot member 210. The base plate 202 includes a screw boss 204. The screw boss 204 can defines a fastener aperture 206, such as an oblong aperture or fastener slot. The screw boss 204 can also define a sloped surface (described further below) that can be adjacent the oblong fastener. The sloped surface can be sloped along an axis interconnecting the foot member 210 and the retention lip 208.

In various embodiments, the retention lip 208 can be disposed on a second end of the base plate 202, the second end opposite the first end. The retention lip 208 can be raised up from a bottom of the base plate 202 creating a space or channel in between the retention lip 208 and the surface to which the self-cinching clip device 200 is secured to aid retaining components such as trim pieces. For example, a projection or fin or a trim piece can fit within the space or channel formed. However, in some embodiments, some components of self-cinching clip device 200 as shown in FIG. 2 can be omitted, such as the retention lip 208.

In various embodiments, the foot member 210 can be disposed on a first end of a base plate 202. In some embodiments, the foot member 210 can have a substantially flat end configured to contact and/or push against a panel or glazing unit when the self-cinching clip device 200 is installed.

The self-cinching clip device 200 can be formed of various materials. In some embodiments, the self-cinching clip device 200 can be formed of a metal, a composite, a polymer, and the like. In various embodiments, the self-cinching clip device 200 can specifically be formed with an injection molded polymer. In various embodiments, the self-cinching clip device 200 can specifically be formed with a 3D printed (such as deposition printed) polymer.

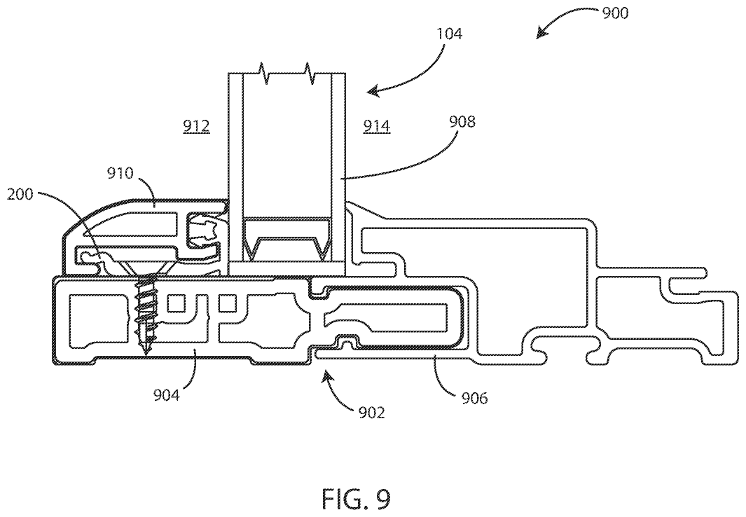

Referring now to FIG. 3, another perspective view of a self-cinching clip device 200 is shown in accordance with various embodiments herein. As before, the self-cinching clip device 200 includes a retention lip 208 and a foot member 210. The screw boss defines an oblong fastener aperture 206 or fastener slot. The bottom surface 302 of the base plate is visible in this view. In this example, the foot member 210 includes an attachment mechanism, such as a snap fit mechanism 212. The attachment mechanism can be used to aid in retaining a component of a fenestration unit such as a trim piece or a trim stop. In some embodiments, such as shown below with respect to FIG. 9, the attachment mechanism can be used in combination with the space or channel in between the retention lip 208 and the surface to which the self-cinching clip device 200 is secured to aid retaining components such as trim pieces. While a snap-fit mechanism is shown in FIG. 3, other connection mechanisms are also included herein such as various friction fit mechanisms, a Christmas tree mechanism, hook and loop mechanisms (such as VELCRO), magnetic mechanisms, adhesive mechanisms, and the like.

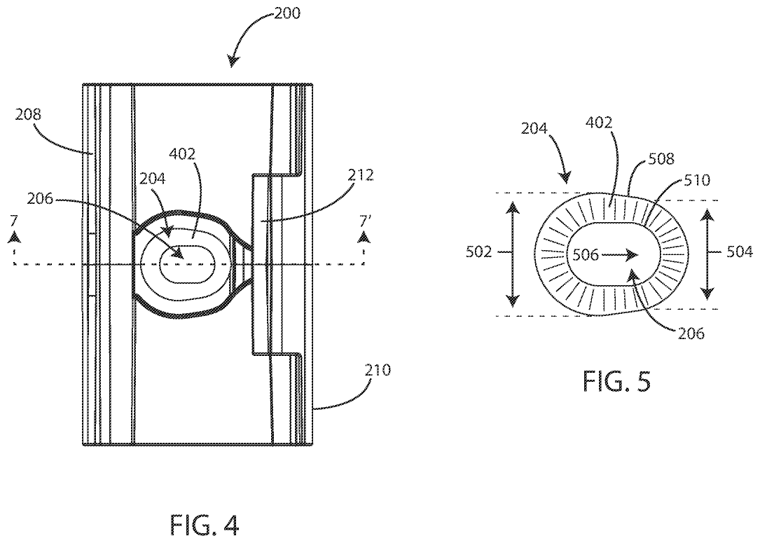

Referring now to FIG. 4, another perspective view of a self-cinching clip device 200 is shown in accordance with various embodiments herein. As before, the self-cinching clip device 200 includes a retention lip 208, a foot member 210, and a screw boss 204. The screw boss 204 defines an oblong fastener aperture 206. The screw boss 204 also defines a sloped surface 402. As before, the foot member 210 includes a snap fit mechanism 212. In some embodiments, the snap fit mechanism 212 (or other attachment mechanism) only extends across a portion of the width of the self-cinching clip device 200. However, in some embodiments, the snap fit mechanism 212 (or other attachment mechanism) extends the entire width of the self-cinching clip device 200. In some embodiments, the snap fit mechanism 212 (or other attachment mechanism) is divided up into discrete segments.

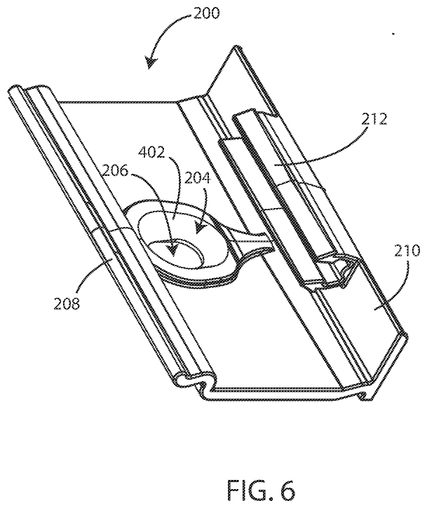

Referring now to FIG. 5, a schematic top view of portions of a screw boss 204 are shown in accordance with various embodiments herein. As can be seen, the screw boss 204 includes a sloped surface 402 bordered on the outside by outer perimeter 508 and on the inside by inner perimeter 510. Inside of the inner perimeter 510 the screw boss 204 can define an oblong fastener aperture 206. The sloped surface 402 can have a shape similar to that of two spaced apart but interconnected counter sunk holes with one having a larger diameter 502 and one having a smaller diameter 504. As such, the shape of the sloped surface can be defined by portions of two interconnected countersunk holes.

As a fastener (such as a countersunk fastener—not shown in this view) is inserted into the screw boss 204, the fastener contacts the sloped surface and the screw boss 204 moves in the direction of arrow 506 as the fastener is driven in (the movement is relative between the fastener and the screw boss 204 and the fastener aligns with the larger diameter 502 counter sunk hole after it is fully driven in). In many embodiments, the counter sink angle of the sloped surface 402 matches the countersink angle of the fastener. However, in some embodiments, the countersink angle of the fastener may be different. In some embodiments, the countersink angle of the sloped surface 402 and/or the fastener can be 82 degrees. However, in other embodiments, the countersink angle of the sloped surface 402 and/or the fastener can be from 65 to 120 degrees, or even greater or lesser. In still other embodiments, the fastener may not be countersunk.

Referring now to FIG. 6, another perspective view of a self-cinching clip device 200 is shown in accordance with various embodiments herein. As before, the self-cinching clip device 200 includes a retention lip 208, a foot member 210, and a screw boss 204. The screw boss 204 defines a sloped surface 402 and an oblong fastener aperture 206. The foot member 210 includes a snap fit mechanism 212.

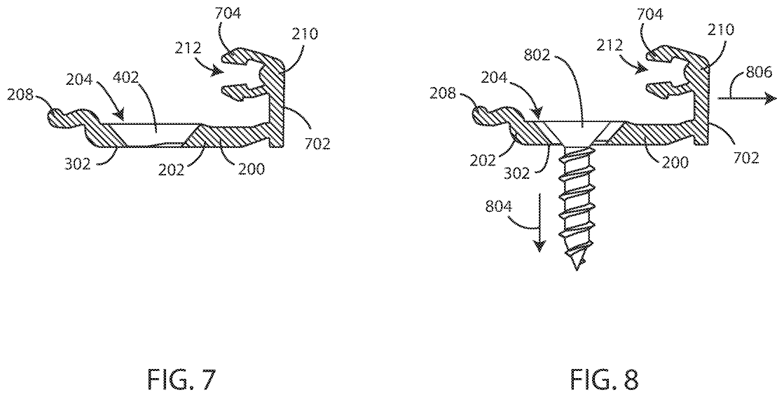

Referring now to FIG. 7, a cross-sectional view of a self-cinching clip device 200 as taken along line 7-7′ of FIG. 4. The self-cinching clip device 200 includes retention lip 208, a foot member 210, base plate 202 includes a screw boss 204. The screw boss 204 defines a sloped surface 402. The base plate 202 also includes a bottom surface 302. The foot member 210 includes an end surface 702. In various embodiments, the end surface 702 can be substantially flat and/or planar and configured to make contact with and/or push against a panel or a glazing unit. For example, in various embodiments the end surface 702 can be configured to make contact with and exert a force against a panel or a glazing unit in a lateral direction such as substantially parallel to an axis interconnecting the foot member 210 and the retention lip 208 and perpendicular to a lengthwise axis of the fastener. In some embodiments, the foot member 210 can be sufficiently tall so as to provide clearance for a trim piece to engage with the snap fit mechanism 212 which is disposed on the opposite side of the foot member 210 from the end surface 702.

While many attachment mechanisms are contemplated herein, in this example snap fit mechanism 212 is used which can include snap fit tabs 704. In various embodiments, the one or more snap-fit tabs are arranged to extend backward from the foot member 210 in a direction toward the retention lip 208. The snap-fit mechanism (or other attachment mechanism) can interface with a component such as a trim piece or trim stop and aid in securing the same to the fenestration unit.

A force in a lateral direction (see arrow 806 in FIG. 8) with respect to the bottom surface 302 of the base plate 202 is generated by a fastener interfacing with the sloped surface 402 as described above with respect to FIG. 5. For example, a portion of the downward force (see arrow 804 in FIG. 8) of the fastener can be translated into force in a lateral direction. The contours of the sloped surface reflecting the relative diameters of the countersunk holes and counter sink angles impacts the proportion of force and/or movement that is translated into to a lateral direction. In various embodiments, the distance between the hole centers can be changed to adjust the amount of force generated in a lateral direction. If not enough lateral force is generated, then the self-cinching clip device 200 may not hold the panel or glazing unit sufficiently tightly. However, if too much lateral force is generated, then excess stress on the panel or glazing unit may result in damage.

Referring now to FIG. 8, a cross-sectional view of a self-cinching clip device 200 showing a fastener 802 being inserted is shown in accordance with various embodiments herein. As before, the self-cinching clip device 200 includes a retention lip 208. The base plate 202 includes a screw boss 204. The base plate 202 also includes a bottom surface 302. A foot member 210 includes a snap fit mechanism 212. Force in direction 804 is changed to force in direction 806 based on the interaction of the fastener 802 with the sloped surface of the screw boss. As such, an end surface 702 of the foot member 210 can be configured to make contact with and exert a force against another component in a direction substantially perpendicular to a plane defined by the end surface 702.

In some embodiments, the fastener 802 can specifically be a screw. In some embodiments, the fastener 802 can include a head with the bottom portion of the head being tapered (such as with a countersunk screw) to facilitate interfacing with the sloped surface of the self-cinching clip device 200. However, many fastener configurations are contemplated herein including both those that are countersunk as well as those that are not.

Referring now to FIG. 9, a schematic sectional view is shown as taken along line 9-9′ of FIG. 1 of components of a fenestration unit 900 in accordance with various embodiments herein. FIG. 9 shows both the interior side 912 of the fenestration unit 900 along with the exterior side 914. The fenestration unit 900 includes a direct set glass side light 104. The direct set glass side light 104 includes a glazing unit 908. It will be appreciated that the glazing unit 908 could be substituted with a panel. The fenestration unit 900 shown also includes a self-cinching clip device 200, a frame member 902, and a trim piece 910. The trim piece 910 can engage both the space or channel underneath the retention lip 208 as well as the attachment mechanism (such as a snap-fit mechanism) of the self-cinching clip device 200. In this manner, the trim piece 910 can be securely held, but is also easily removable.

The frame member 902 can be a jamb member such as part of a side jamb or a head jamb. In some embodiments, the frame member 902 can be part of a sill. The frame member 902 can also be part of other fenestration components.

In this example, the frame member 902 includes an interior portion 904 and an exterior portion 906. However, in other examples, the frame member 902 may only include a single piece. In this case, the self-cinching clip device 200 is fastened against the interior portion 904 with a screw and exerts a force against the panel or glazing unit 908. The interior portion 904 of the frame member can fit against the panel or glazing unit from the opposite side as the self-cinching clip device 200. In some embodiments, the amount of force exerted against the panel or glazing unit 908 can be about 3 to 5 lbs per lineal inch which can be sufficient in some configurations to securely hold the panel or glazing unit 908 but not generate undue stresses thereon that could lead to damage. It will be appreciated, however, that in other configurations other amounts of force are also contemplated herein.

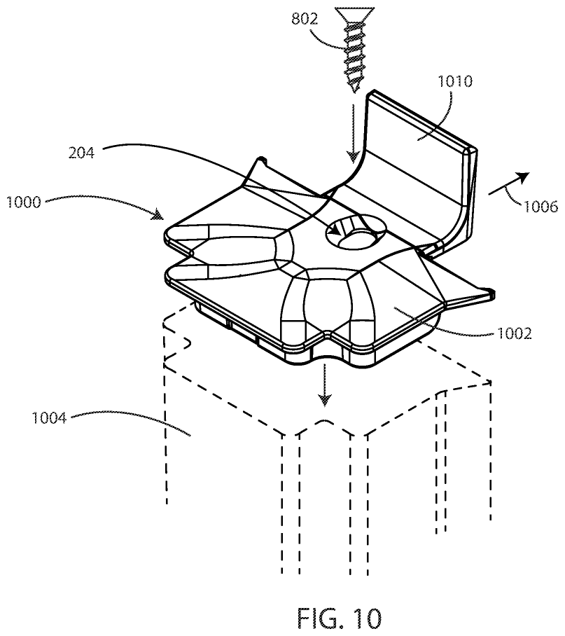

It will be appreciated that self-cinching devices herein can take on many different forms. Referring now to FIG. 10, a perspective view of a self-cinching device 1000 in accordance with various embodiments herein. In this embodiment, the self-cinching device 1000 takes the form of a self-cinching cap device (e.g., serving as a cap on the end of a lineal). The device 1000 includes a base plate 1002 and foot member 1010. The device 1000 also includes a screw boss 204. In this embodiment, the device 1000 fits over the end of a lineal profile member 1004 (which could be a structural member, a non-structural member, a frame member, or the like, or specifically could be an astragal). As a fastener 802 is driven through the screw boss 204 and into the lineal profile member 1004, the device 1000 moves in the direction of arrow 1006 and the foot member 1010 may come to rest against and/or exert a force against another component and/or surface of a fenestration unit, such as a datum wall or the like.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method of securing a panel or glazing unit within a frame member is included. The method can include placing the panel or glazing unit into contact with the frame member and placing a self-cinching clip device on a surface of the frame member adjacent the panel or glazing unit. The self-cinching clip device can include a base plate having a screw boss. The screw boss can include define an oblong fastener aperture or slot and can define a sloped surface. The sloped surface can be adjacent the oblong fastener aperture or slot. The method can include driving a fastener with a head through the oblong fastener aperture and into the frame member sufficiently far to make contact between the fastener head and the sloped surface and then further driving the fastener causing the self-cinching clip device to move in a direction parallel with the surface of the frame member towards the panel or glazing unit as the head of the fastener moves along the sloped surface and exert a force on the panel or glazing unit.

In an embodiment of the method, the self-cinching clip device exerts a force on the panel or glazing unit of about 3 to 5 lbs per lineal inch. In an embodiment of the method, the self-cinching clip device the fastener is driven to a final point at a torque of 13 to 16 inch pounds.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A self-cinching clip device comprising:
a base plate, the base plate comprising
a screw boss;
the screw boss defining an oblong fastener aperture; and
defining a sloped surface, wherein the sloped surface is adjacent the oblong fastener aperture;
a foot member, wherein the foot member is disposed on a first end of the base plate;
a retention lip, wherein the retention lip is disposed on a second end of the base plate, the second end opposite the first end; and
wherein the sloped surface has a first side and a second side opposite the first side along an axis interconnecting the foot member and the retention lip, wherein the first side has a larger diameter than the second side.

2. The self-cinching clip device of claim 1, wherein the sloped surface is sloped at a countersink angle of 65 to 120 degrees.

3. The self-cinching clip device of claim 1, wherein the self-cinching clip device is formed of an injection molded or 3D printed polymer.

4. The self-cinching clip device of claim 1, wherein the self-cinching clip device is at least partially formed of a metal.

5. The self-cinching clip device of claim 1, the foot member comprising an end surface, wherein the end surface is configured to make contact with and exert a force against a panel or a glazing unit in a direction substantially parallel to an axis interconnecting the foot member and the retention lip.

6. The self-cinching clip device of claim 1, the foot member comprising one or more connection mechanisms.

7. The self-cinching clip device of claim 6, wherein the one or more connection mechanisms are arranged to extend backward from the foot member in a direction toward the retention lip.

8. The self-cinching clip device of claim 6, the one or more connection mechanisms comprising one or more snap fit tabs.

9. The self-cinching clip device of claim 1, wherein the shape of the sloped surface is defined by portions of two interconnected countersunk holes.

10-16. (canceled)

17. A fenestration unit comprising:
a structural member;
a panel or glazing unit; and
a self-cinching clip device, the self-cinching clip device comprising
a base plate, the base plate comprising
a screw boss;
the screw boss defining an oblong fastener aperture; and
defining a sloped surface, wherein the sloped surface is adjacent the oblong fastener aperture;
a foot member, wherein the foot member is disposed on a first end of the base plate;
wherein the self-cinching clip device is connected to the structural member and exerts a force against the panel or glazing unit; and
wherein the sloped surface has a first side and a second side opposite the first side along an axis interconnecting the first end of the base plate and an opposite end of the base plate, wherein the first side has a larger diameter than the second side.

18. The fenestration unit of claim 17, the self-cinching clip device further comprising a retention lip, wherein the retention lip is disposed on a second end of the base plate, the second end opposite the first end.

19. The fenestration unit of claim 17, wherein the sloped surface is sloped at a countersink angle of 65 to 120 degrees.

20. The fenestration unit of claim 17, the foot member comprising an end surface, wherein the end surface is configured to make contact with and exert a force against a panel or a glazing unit in a direction substantially parallel to an axis interconnecting the foot member and the retention lip.

21. The fenestration unit of claim 17, the foot member comprising one or more connection mechanisms.

22. The fenestration unit of claim 21, wherein the one or more connection mechanisms are arranged to extend backward from the foot member in a direction toward a retention lip.

23. (canceled)

24. The fenestration unit of claim 17, the structural member comprising a jamb member.

25. The fenestration unit of claim 17, wherein the shape of the sloped surface is defined by portions of two interconnected countersunk holes.

26. A fenestration unit comprising:
a first component;
a second component; and
a self-cinching device, the self-cinching device comprising
a base plate, the base plate comprising
a screw boss;
the screw boss defining an oblong fastener aperture; and
defining a sloped surface, wherein the sloped surface is adjacent the oblong fastener aperture;
a foot member, wherein the foot member is disposed on a first end of the base plate;
wherein the self-cinching device is connected to the first component and exerts a force against the second component; and
wherein the sloped surface has a first side and a second side opposite the first side along an axis interconnecting the first end of the base plate and an opposite end of the base plate, wherein the first side has a larger diameter than the second side.

27. The fenestration unit of claim 26, the self-cinching device further comprising a retention lip, wherein the retention lip is disposed on a second end of the base plate, the second end opposite the first end.

28. (canceled)

29. The fenestration unit of claim 26, the foot member comprising an end surface, wherein the end surface is configured to make contact with and exert a force against the second component in a direction substantially perpendicular to a plane defined by the end surface.

30-35. (canceled)
